(19) United States
(12) Patent Application Publication
(10) Pub. No.: US 2014/0062110 A1
(43) Pub. Date: Mar. 6, 2014

(54) CAR SEAT CARRYING DEVICE

(71) Applicants: Jarolsaw Bednarski, Chicago, IL (US); Andrzej Skrzyniarz, Des Plaines, IL (US)

(72) Inventors: Jarolsaw Bednarski, Chicago, IL (US); Andrzej Skrzyniarz, Des Plaines, IL (US)

(21) Appl. No.: 13/469,039

(22) Filed: May 10, 2012

(51) Int. Cl. B65G 7/12

(52) U.S. Cl. 294/15

(57) ABSTRACT

A car seat carrying device utilized to carry a car seat, that includes a tubular elongated body that serves as a main support of the car seat carrying device and a pair of adjustable handles that are disposed on the proximal end and the distal end of the generally elongated body, wherein the adjustable handles are slidably retracted and extended outward. The car seat carrying device also includes a pair of permanent handles that extend perpendicularly from the elongated body and receive and accommodate the car seat to be lifted and carried by the car seat carrying device and a snap-on attachment device that removably secures the car seat between the permanent handles of the car seat carrying device and the snap-on attachment device that is disposed on the elongated body.

### TECHNICAL FIELD & BACKGROUND

Individuals with infants often find carrying the car seat to be both difficult and uncomfortable for one person. Currently, there are limited traditional devices available which assist two individuals in carrying car seats comfortably and efficiently.

The present invention generally relates to a carrying device. More specifically, the invention is a car seat carrying device.

It is an object of the invention to provide a car seat carrying device that allows two people to relatively easily carry a car seat and baby seating in the car seat.

It is an object of the invention to provide a car seat carrying device that has a pair of adjustable and extendable handles to facilitate safely lifting and carrying a baby and a car seat.

What is really needed is a car seat carrying device that allows two people to relatively easily carry a car seat and a baby seating in the car seat that has a pair of adjustable and extendable handles to facilitate safely carrying a baby and a car seat.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a car seat carrying device, according to an embodiment of the present invention.

FIG. 1B illustrates a top view of a car seat carrying device, according to an embodiment of the present invention.

FIG. 1C illustrates a side view of a car seat carrying device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

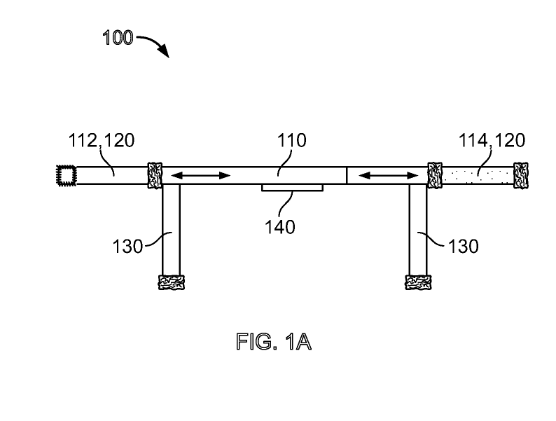

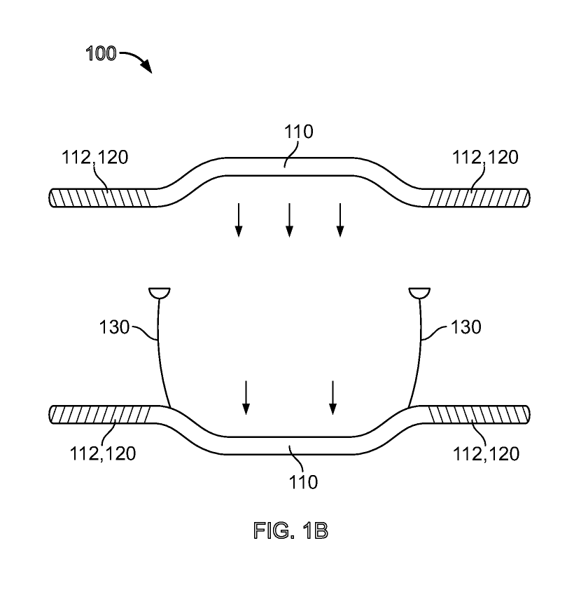

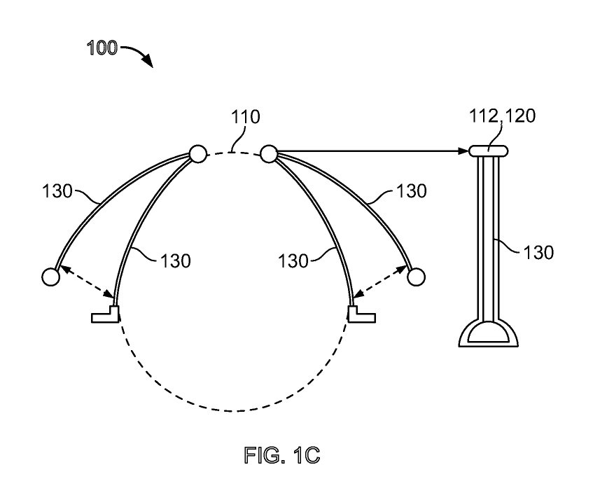

FIG. 1A illustrates a front view of a car seat carrying device 100, according to an embodiment of the present invention. The car seat carrying device 100 can be made of metal, plastic or other suitable material.

The car seat carrying device 100 includes a tubular elongated body 110, a pair of adjustable handles 120 and a pair of permanent handles 130 and a snap-on attachment device 140. The elongated body 110 has a proximal end 112 and a distal end 114 and serves as a main support of the car seat carrying device 100. The pair of adjustable handles 120 are disposed on the proximal end 112 and the distal end 114 of the generally elongated body 110, where one adjustable handle 120 is attached to the proximal end 112 and the another adjustable handle 120 is attached to the distal end 114 of the generally elongated body 110. The adjustable handles 120 can be slidably extended outward in the range of six inches to eight inches, or other suitable extending range, allowing two users to facilitate carrying the car seat (not shown) from both sides of the car seat carrying device 100. The adjustable handles 120 adjustably slide internally within the elongated body 110 and can be secured in place with any suitable securing fastener. The pair of permanent handles 130 extend perpendicularly from the elongated body 110 and receive and accommodate a car seat to be lifted and carried by the car seat carrying device 100. The snap-on attachment device 140 is disposed on the elongated body 110 and removably secures the car seat between the permanent handles 130 of the car seat carrying device 100.

FIG. 1B illustrates a top view of a car seat carrying device 100, according to an embodiment of the present invention. The car seat carrying device 100 illustrated in FIG. 1B includes the same tubular elongated body 110, pair of adjustable handles 120 and pair of permanent handles 130 that is illustrated and described in FIG. 1A.

FIG. 1C illustrates a side view of a car seat carrying device 100, according to an embodiment of the present invention.

The car seat carrying device 100 illustrated in FIG. 1C includes the same tubular elongated body 110, pair of adjustable handles 120 and pair of permanent handles 130 that is illustrated and described in FIG. 1A. The car seat carrying device 100 that is illustrated in FIG. 1C is flexible and is bent into position to secure itself to an existing car seat (not shown).

Comprised of two additional handles to lift and carry a car seat, the car seat carrying device is a suitable alternative to current similar car seat carrying device products. The car seat carrying device is relatively easy to use and includes a pair of handles that are provided on each side of the car seat carrying device that extend approximately in the range of six inches to eight inches, allowing two users to facilitate carrying the car seat. The car seat carrying device may be readily available in a variety of colors and styles to suit any existing car seat color and style. Among those who will find the car seat carrying device both practical and convenient, are baby product manufacturing companies, baby specialty stores as well as retail stores and everyday parents or caregivers. The car seat carrying device also features a pair of extra handles capable of extending a second pair of car seat handles in the range of approximately six inches to eight inches in length, effectively facilitating carrying and offering relatively better comfort and weight distribution. The car seat carrying device is designed to either be an attachment fastened onto an existing car seat or built into a new car seat. The car seat carrying device can be snapped on, moved up or down and slides out sideways to accommodate users on both sides of the car seat carrying device.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1.-20. (canceled)

21. A car seat carrying device, comprising:
a tubular elongated body with a proximal end and a distal end, wherein said elongated body is defined by a first portion and a second portion which is disposed in parallel to said first portion and is a mirror image of the first portion;
a first handle portion attached to said proximal end of the first portion and the second portion, wherein said first handle portion is adapted to receive and be grasped by a first user's hand;
a second handle portion attached to said distal end of the first portion and the second portion, wherein said second handle portion is adapted to receive and be grasped by a second user's hand; and
a two handle members permanently attached to said second portion, wherein said handle members each extend perpendicularly from said second portion and are together adapted to receive a conventional car seat.

22. The car seat carrying device of claim 1, additionally comprising an attachment device adapted to engage a conventional car seat.
